(19) United States
(12) Patent Application Publication
(10) Pub. No.: US 2026/0143192 A1
(43) Pub. Date: May 21, 2026

(54) NEUROANALYSIS OF HUMAN RESPONSE TO MEDIA CONSUMPTION

(71) Applicant: GLASSVIEW LLC, Fort Worth, TX (US)

(72) Inventor: James G. Brooks, Jr., Fort Worth, TX (US)

(21) Appl. No.: 18/955,529

(22) Filed: Nov. 21, 2024

(51) Int. Cl. H04N 21/442; H04N 21/466

(52) U.S. Cl. CPC H04N 21/44213; G06Q 30/0203; G06Q 30/0204; G06Q 30/0244; G06Q 30/0245; H04N 21/4662

(57) ABSTRACT

This disclosure describes systems, software, and computer implemented methods that include identifying a set of baseline neurometrics for a first subset of an audience; exposing the first subset of the audience to a collection of media and measuring neurometrics of the audience during exposure to the media; identifying demographic data associated with the first subset of the audience, wherein the demographic data includes a plurality of parameters associated with individual members of the audience; identifying demographic data associated with a second subset of the audience, the second subset of the audience comprising audience members that respond to at least a portion of the collection of media; and generating a predictive model of the audience's response to the collection of media by.

### BACKGROUND

Modern human behavior is influenced by a diverse set of complex criteria. Environmental factors, social factors, individual factors and other each effect how a person responds to certain media, which is difficult to predict. By measuring neurological response during consumption of media, a better model for human behavior can be developed.

### SUMMARY

The present disclosure involves systems, software, and computer implemented methods for predicting a behavioral response to media. This can include identifying a set of baseline neurometrics for a first subset of an audience; exposing the first subset of the audience to a collection of media and measuring neurometrics of the audience during exposure to the media; identifying demographic data associated with the first subset of the audience, wherein the demographic data includes a plurality of parameters associated with individual members of the audience; identifying demographic data associated with a second subset of the audience, the second subset of the audience comprising audience members that respond to at least a portion of the collection of media; generating a predictive model of the audience's response to the collection of media by: generating a network comprising three layers of nodes, each node in the first layer of nodes representing a particular neurometric, each node in the second layer of nodes representing a particular parameter of the demographic data, and each node in the third layer representing a response type associated with the collection of media; generating a first group of edges between each node in the first layer of nodes and each node in the second layer of nodes; generating a second group of edges between each node in the second layer of nodes, and each node in the third layer of nodes; for each individual member of the first subset of the audience, adjusting a weight of each edge of the first group of edges; and for each individual member of the second subset of the audience, adjusting a weight of each edge of the second group of edges.

Implementations can optionally include one or more of the following features.

In some instances, measuring neurometrics includes analyzing brainwave data to identify a psychological state of each individual of the first subset of the audience, wherein each neurometric represents a particular psychological condition for each individual.

In some instances, the baseline neurometrics include brainwave measurements of the first subset of the audience during a period when the first subset of the audience is not exposed to the media.

In some instances, methods and operations further include determining based on the baseline neurometrics, whether the first subset of the audience is sufficiently representative of the audience by determining that a neurosynchrony between members of the first subset of the audience is above a predetermined threshold.

In some instances, audience response to the portion of the media includes at least one of: a view, a selection of a hyperlink associated with the media; a sale associated with the media; a change in market share associated with the media; or a reported sentiment improvement associated with the media.

In some instances, the demographic data comprises at least one of: age; location; time; frequency of media exposure; or platform of media exposure.

In some instances, adjusting the weight of each edge of the first group of edges and adjusting the weight of each edge of the second group of edges comprises adjusting the weights using a stochastic gradient descent algorithm.

In some instances, methods and operations include identifying one or more phenotypes of the audience based on the predictive model; and generating a list of most common audience phenotypes. In some instances,

The details of these and other aspects and embodiments of the present disclosure are set forth in the accompanying drawings and the description below. Other features, objects, and advantages of the disclosure will be apparent from the description, drawings, and claims.

### DESCRIPTION OF DRAWINGS

Some example embodiments of the present disclosure are illustrated by way of example and not limitation in the figures of the accompanying drawings.

FIG. 1 illustrates a schematic diagram of an example system for predicting a behavioral response to media.

FIG. 2 is a schematic diagram of an example implementation of a system for predicting a behavioral response to media.

FIG. 3 is a flowchart of an example process for improving generation of media using a predicted behavioral response to media.

FIG. 4 is a flowchart of an example process for classifying phenotypes based on a behavioral response to media.

FIG. 5 is a Venn diagram showing an example audience and subsets.

FIG. 6 is a schematic diagram of example computer systems that can be used to execute implementations of the present disclosure.

### DETAILED DESCRIPTION

This disclosure describes methods, software, and systems for predicting a behavioral response to media.

Conventionally, media providers attempt to reach a target audience by tailoring the media they present to that audience. Focus or test groups can be created, and surveys or performance data can be recorded to identify successful or unsuccessful media. However, comparing an audience response to their associated demographics does not adequately capture a full determination of why an audience member reacts or responds to media. Further, it is difficult to identify which particular demographic or characteristics of a demographic have the largest impact on audience response, and thus, effectiveness of the media.

This disclosure presents a solution where audience neurometrics are measured and analyzed in addition to demographics, thereby developing a deeper understanding of the reason a particular reaction is achieved for a sample of media. Using these techniques, insights can be developed regarding how to improve or modify the media to target more specific or broader audiences, as well as to have a greater impact on those audiences. Additionally, these techniques can be used to provide improvements to media itself, or the creative process of generating the media. Neurometrics includes monitoring of brainwave data to analyze the emotional and psychological state of the user and can measure things such as joy, empathy, confusion, contempt, trust, disgust, fear, impulse, fatigue, attention, or other mental conditions. By measuring neurometrics and comparing them to a broad range of demographics (e.g., age, race, religion, location, marital status, etc.), certain trends can be identified and classified. A network of characteristics can be developed and relationships between those characteristics adjusted. That is, the network can be trained in order to generate a predictive model that provides insights regarding how certain media will affect target audiences or even particular individuals. In some instances, those insights can then be used to automatically modify campaigns and/or marketing based on the target audience, or to focus particular campaigns to particular audiences that are predicted to most positively relate or react to the media. Further, the identified trends and classifications can be isolated to generate new or unique phenotypes from amongst the audience. These phenotypes can be useful in better understanding future audience reactions.

This disclosure realizes advantages in the field of digital communication by more precisely measuring the impact of certain media on many individuals. This impact data can be used to tailor the digital communication, improving its effectiveness. In some instances, the media itself can be changed, while in others, the particular audience to whom certain media and/or a certain campaign associated with the media can be targeted can be tailored based on insights obtained through the solution. An additional advantage is that the solution enables the discovery of trends and value sets in disparate groups of people and allows the solution to classify those groups of people automatically into particular phenotypes. The described solution uniquely enables measurement of complex human reactions to digital media by measuring human response across multiple dimensions.

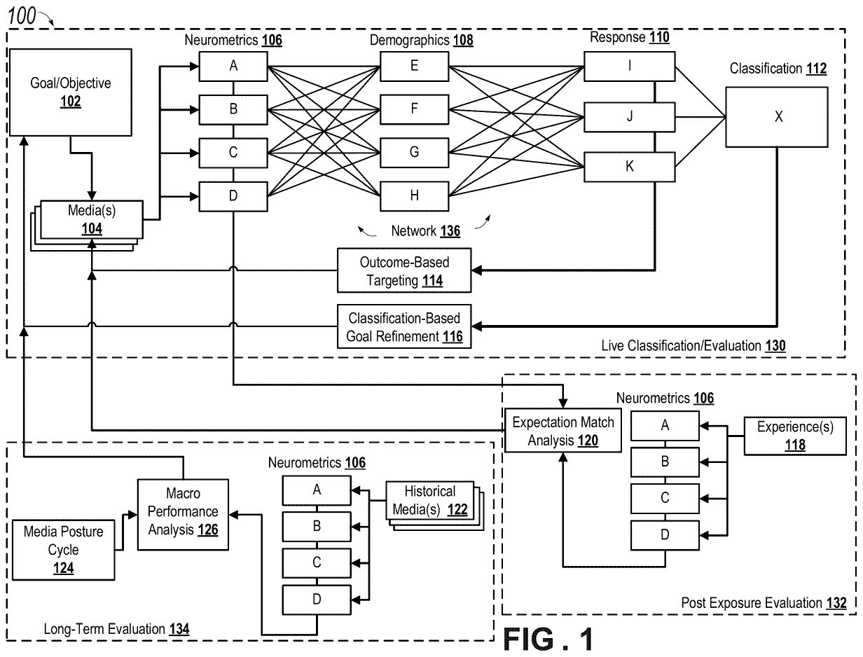

FIG. 1 illustrates a schematic diagram of an example system for predicting a behavioral response to media. In general, the system 100 involves a live classification and evaluation portion 130 which uses a network of nodes and edges between neurometrics 106, demographics 108, and responses 110 to identify and generate classifications 112 and response driven data. A post-exposure evaluation 132 can be performed to further enhance the digital communication or media and a long-term evaluation 134 can be performed to refine strategic goals and objectives. Each evaluation (130, 132, and 134) is enhanced using measured neurometrics.

The live classification 130 involves selecting a goal or objective 102 to be communicated to an audience. The goal/objective 102 can be the successful communication of a specific piece of information, a particular message (e.g., a campaign message), and/or a certain action or response from the audience (e.g., click, view, buy, interact, vote, etc.). In some implementations, successful communication can be considered a communication where the audience is able to internalize the message, or in some cases, capable of taking an action in response. In some implementations, successful communication can be measured, for example, based on a percentage of a screen displaying the media in an unobstructed manner. In some implementations, successful communication can be determined based on a click-through rate, or dwell time upon landing at a website associated with the media. In furtherance of the goal 102, a set of media 104 can be produced. The media 104 can include, for example, videos, images, audio clips, songs, or a combination thereof. In some implementations, the media can be a set of advertisements or an advertising campaign. In some implementations, the media 104 can be a campaign message or a public service announcement. The media 104 can be presented to an audience through any suitable medium, such as within a website, television advertisement, article, banner or inlay, radio advertisement, or sign or image, among others.

For at least a portion of the audience, neurometrics 106 are recorded when the audience consumes the media 104. Neurometrics 106 can be the result of an analysis of brainwave patterns that can be collected for the audience members. For example, an electroencephalograph (EEG) can be recorded of a user over a period of time and during consumption of media 104. The EEG can be analyzed, including a wave analysis of alpha, beta, delta, theta, and gamma brain waves, to identify a psychological state of the user. This measured psychological state can include numerical or relative scores for various neurometrics 106 such as joy, recall, attention, fatigue, disgust, etc. In some implementations, neurometrics 106 are recorded in a lab-type setting. That is, a subset of the audience is selected and baseline neurometrics 106 are recorded during a period of rest or otherwise minimal stimulation, and then the neurometrics 106 are re-recorded during exposure to the media 104. In this matter, the neurological impact of each media 104 can be precisely measured. In some implementations, neurometrics 106 are recorded during normal every-day activity and can be recorded continuously or near-continuously over a certain period. For example, the audience or a portion of the audience can use a wearable EEG device such as the Cogwear™ headband, or the Ceribell® EEG system, among others. In some implementations, a combination of lab recorded and live recorded neurometrics 106 can be used.

In addition to recording neurometrics 106, demographics of the audience are identified 108, and can be recorded and/or associated with the particular audience members. These demographics 108 can include, but are not limited to, socioeconomic factors (e.g., income, occupation, education, societal class), geographic factors (e.g., population density, location/region, country, etc.), individual factors (e.g., age, gender, race/ethnicity, religion, marital status, family size, homeownership, etc.), and psychographic factors (e.g., lifestyle, personality, values, interest, opinions, etc.).

Often relationships may exist between the measured neurometrics 106 and the demographics 108 that are not intuitive or obvious but can be a reliable indicator of specific responses 110. Responses 110 can be a reaction or action taken because of, or in light of, the consumed media 104, and can include, for example, a click, selection, view, sentiment change, increase in productivity, change in mental health, or other response. In some implementations, the goal 102 is to influence or increase the occurrence of a specific response 110. When an audience member responds, they do so in the context of the consumed media 104, their physiological state as indicated by neurometrics 106, and their associated demographics 108. The actions taken by the audience members can be collected and stored for evaluation of whether the communication is successful or a desired

A network 136 of edges and nodes can be created between the neurometrics 106, demographics 108, and responses 110 with each edge having a weight associated with the strength of the relationship between nodes. By analyzing datasets and past responses, the weighting between nodes can be adjusted to result in a predictive or classification network that can be used to identify classes or phenotypes under classifications 112. These phenotypes can be personality phenotypes, customer phenotypes, or other particular phenotypes that may emerge only in specific audiences such as “female executive travelers” or “motorcyclists who purchase stuffed animals,” etc. Phenotypes can be identified based on pathways through the network 136 that have a correlation or associated weights greater than a predetermined amount. For example, the network 136 can be “trained.” That is, an initial weight of 0 (on a scale of −1 to 1) can be assigned for each edge. Then, as responses 110 are observed, the associated edge weights can be increased or decreased for certain demographics 108 and neurometrics 106 accordingly using machine learning techniques (e.g., stochastic gradient descent, etc.).

The weighted network 136 can be used to generate improved outcome-based targeting 114. For example, specific items of media 104 can be selected to target certain phenotypes or sub-audiences within the audience. In another example, media 104 can be selected that is more or less likely to induce a particular response 110.

Additionally, the media 104 itself can be modified or enhanced based on the weights and prediction of the network 136. For example, if one sample of the media 104 is observed to induce a certain neurometric 106, which is known to be particularly influential in inducing a certain response 110 amongst particular demographics 108, additional media samples can be generated that are similar to the one sample. Similarly, existing media samples similar to the one sample may be selected for delivery to others of the same or similar demographics. In some implementations, the media 104 is refined automatically. For example, the outcome-based targeting 114 can provide a prompt or updated parameters to a generative AI model (e.g., image generator or video generating neural network such as stable diffusion, DALLE-3, or others) which can produce new media 104 that better aligns with a target response 110.

Further, classification-based goal refinement 116 can improve the overall system goal or objective 102. The goal or objective 102 can be refined based on the discovery of new phenotypes or classes in classification 112. For example, an initial goal may be to induce a high level of “joy” in the neurometrics 106. However, the classifications 112 may reveal that there is a large audience that is more likely to respond to “anger” or “frustration.” In response, the goal 102 can be shifted and new media 104 developed accordingly. In some implementations, suggested improvement are automatically generated and presented based on the classification-based goal refinement 116. In some implementations, the goals are automatically refined. For example, the classification-based goal refinement 116 can include providing an updated prompt or set of prompts to a large language model, which can return an example goal/objective 102 that alights with the identified classifications 112.

Post-exposure evaluation 132 can be a follow-on process that is used to further refine the media 104 and/or goals 102. In the post-exposure evaluation 132, audience members who have an experience that is related to the media 104 can have their neurometrics 106 recorded and analyzed during or immediately following the experience. For example, an audience member who observes an advertisement and then purchases an associated service, can have their neurometrics recorded during both consumption of the media (e.g., advertisement) and the experience. An expectation match analysis can be performed 120 to identify whether the audience member's expectation based on the media was satisfied by their experience.

Measuring the difference between the two can provide an adequate baseline of a perception-based reaction to the media 104 or associated product. For example, consider two groups, one group that is not exposed to the brand “Coca-Cola”, and the second group who are exposed to the brand Coca-Cola and, in some instances, may be shown Coca-Cola commercials. A measure in the different neurometrics of each group can provide a baseline of neurometric perception to Coca-Cola. Then, the same group that was exposed to the Coca-Cola brand can be asked to drink Coca-Cola. This groups' neurometric reaction can be measured, and the differences and similarities between their perception of the brand when it is simply mentioned and when it is actually experiencing can be analyzed. Continuity of neurological reaction can be a predictor of brand health or identity, and continuity of neurometrics can identify the customer experience gap. The larger the gap, the higher the dissatisfaction.

Long term evaluation 134 can include an evaluation of an entity over its lifetime by presenting historical media samples 122 and measuring similar neurometrics 106 during exposure. These neurometrics can be compared with a media posture cycle 124 to identify where the entity is or how the entity is performing.

For example, business entities can follow a cycle of generating emotional responses then establishing credibility before presenting logic based or informative media. For example, a start-up company typically tries to induce an emotional reaction to stand out as unique or special. As that start-up gains market share, they shift into establishing credibility in order to outcompete their peers. When the company is a dominant market force, it then shifts again to providing information rich or logical advertisements highlighting the features that make it unique compared to its competitors. Often companies or entities will pass through this cycle repeatedly as their public perception shifts.

A macro performance analysis 126 can be performed to assess where an entity is within the posture cycle 124. This assessment can be based on the measured neurometrics 106 of an audience consuming historical media 122. This analysis 126 can identify where in the posture cycle 124 an entity is, as well as what they should do (e.g., focus on emotion, or credibility) to achieve their stated goals/objectives 102. This macro performance analysis 126 can further inform and enhance an entity's selected goals 102.

For example, by analyzing thousands of commercials that have aired over a period of time (e.g., the last 50 years) and pairing those commercials with the company stock prices (e.g., on an inflation-adjusted, logarithmic scale) or another metric which can represent a proxy for market share inflection points, patterns can be identified that drive market share adoption at different points of a brand evolution. In some implementations, early on in market adoption curve, high emotion is most effective. After a brand or product is adopted by ‘innovators’ and ‘early adopters’, brands that break into early and later majority have to effectively display high credibility. This can be identified neurologically-speaking by higher levels of neurosynchrony and lowered impulse gauge. Regarding late stages of the market share diffusion curve, for a brand to attract even the laggards, brands have to demonstrate that they drive ‘value’, have been adopted by most of the market, and are the logical choice (e.g., that they are priced right and have the technical components that make them the logical choice).

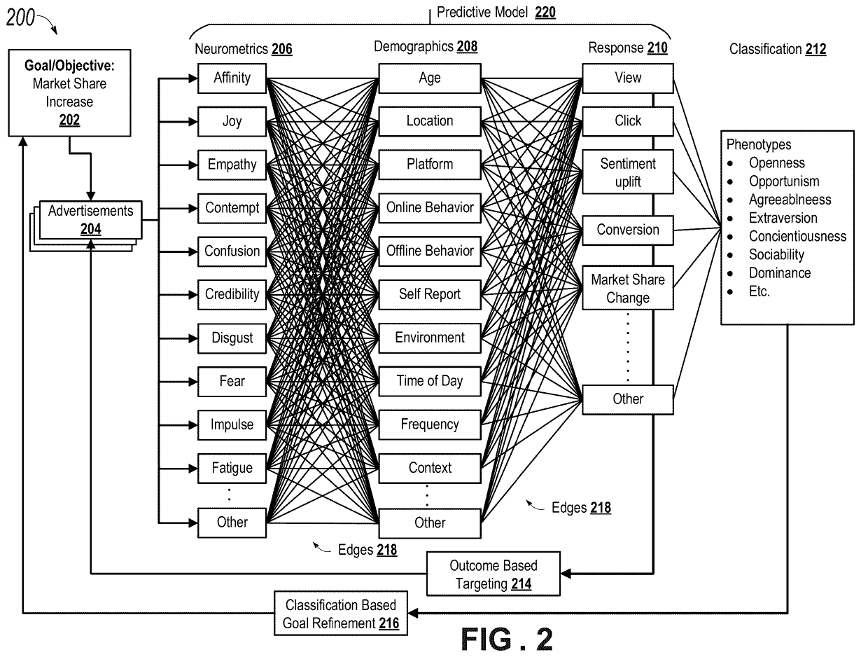

FIG. 2 is a schematic diagram of an example 200 implementation of a system for predicting a behavioral response to media. The example in FIG. 2 relates to online advertising, however, it should be noted that this disclosure can be applied to any media or communication, including campaigning, informational presentations, training, performance review or other communications.

The stated objective 202 of example 200 is for a company to increase market share. As such, advertisements 204 will be generated that can show that the company provides products or features that are superior to the competition. A range of neurometrics 206 can be measured during audience consumption of the advertisements 204. In the illustrated example, the neurometrics 206 include affinity, joy, empathy, contempt, confusion, credibility, disgust, fear, impulse, fatigue, and others. Each of these can be measured, for example, using an EEG and performing a brainwave analysis of the audience before, during, and after consumption of the advertisements 204. Any other suitable manner of obtaining some or all of the neurometrics 206 can also be used in the alternative or in combination with the EEG.

It should be noted that the entire audience need not have neurometrics 206 measured. A subset of the audience can be sufficient. In some implementations, an analysis can be performed to determine whether the subset is large enough to be representative of the overall audience. For example, a statistical analysis including a measurement of standard deviation for each neurometric 206 can identify whether the subset of the audience has sufficient neurosynchrony to be representative of the larger audience. For example, in groups with high neurosynchrony, as few as 50 individuals can accurately predict the outcome for millions. With lower neurosynchrony, larger subsets are required.

Demographics 208, for example 200, can include age, location, platform upon which the advertisement is consumed, an audience member's online and offline behavior, self-reported data, their environment, time of day for advertisement exposure, frequency of advertisement exposure, context and others. In some implementations, the demographics data 208 is provided by one or more third party services such as Google Ads, Stirista, or other services. In some implementations, demographics 208 can further include stock market parameters such as stability, volatility, earning reports, weather, or other information.

The responses 210 that can be observed, or actions or responses that the audience can take, include views, clicks or website accesses, sentiment uplift as measured by self-reporting or other techniques, conversion (e.g., the sale of a product following a click of an advertisement), a market share change, or others. Responses 210 can be observed over time (e.g., while an advertising campaign is being executed) or directly by survey or self-reporting of a portion of the audience.

Each set of nodes (neurometrics 206, demographics 208, and response 210) can form a layer that is interconnected with edges 218. This can form a network similar to a neural network, which can be trained using machine learning training techniques, such as stochastic gradient descent, mini-batch gradient descent, ADAM, RMSprop, L1 or L2 regularization or other techniques. These techniques can be used to adapt the relative weights of the edges 218 within the network in order to generate a predictive model 220 associated with the advertisements 204 and the audience. This predictive model 220 can be used to target specific responses 210 or as a classification model to generate classifications 212.

Classifications 212 in the illustrated example show personality classifications as well as other phenotypes that can be discovered in response to identifying certain relationships between neurometrics 206, demographics 208, and the advertisements 204. In some implementations, the classifications 212 are generated during the training of the network. In some implementations, a list of classifications 212 can be provided and fitted to the predictive model 220.

The response 210 to an advertising campaign can be reviewed and fed back as outcome-based targeting 214 to the advertisements 204. That is, certain advertisements 204 may be more or less effective at activating specific pathways in the network that lead to the desired result 210. In some implementations, the predictive model 220 and the advertisements are iterated, with the model being trained, and then used to generate new advertisements 204, or alternatively, to provide information regarding the types or tone of new advertisements 204 to be generated, after which the model is trained on the newly created advertisements. In some implementations, these changes can be made real-time or near real-time. For example, a color in a sample of media 104 can be changed from red to blue in order to invoke certain neurometric responses and ultimately influence different demographics or yield a different final result.

In addition to providing targeting feedback for the advertisements 204, the classifications can provide insights into the accuracy of the goal 202. In the illustrated example, the stated goal is a market share increase. However, after training the predictive model 220, it may become apparent that there is a large phenotype within the audience that seeks “offbeat” or smaller brands, and thus, increasing market share may be a poor objective; instead, sentiment uplift or conversion rate would be more effective goals.

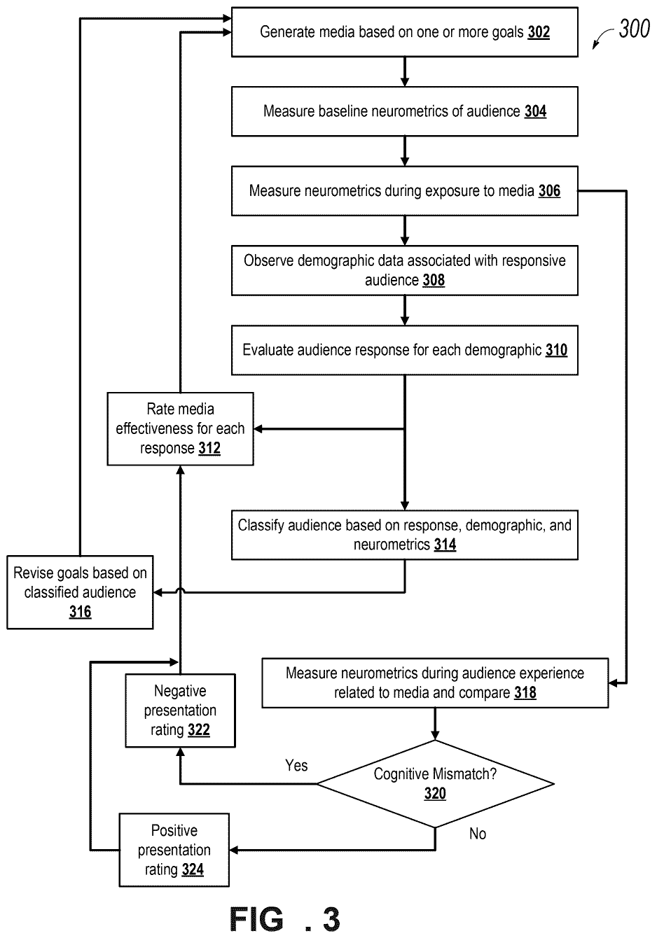

FIG. 3 is a flowchart of an example process 300 for improving generation of media using a predicted behavioral response to media. It will be understood that process 300 and related methods may be performed, for example, by any suitable system, environment, software, and hardware, or a combination thereof, as appropriate. For example, a system comprising a communications module, at least one memory storing instructions and other required data, at least one hardware processor interoperably coupled to at least one memory and the communications module can be used to execute process 300. In some instances, some or all of a portion of system 100 may be used to perform the operations of process 300.

At 302, media is generated for consumption based on one or more goals or objectives for an entity. Media can be any form of communication including, but not limited to, advertisements, speeches, announcements, pamphlets, videos, music or audio clips, etc. Media can also exist on any suitable platform such as a website, social media platform, television broadcast, internet broadcast, virtual reality images or video, or others. The media, sometimes referred to as a “creative,” is produced with the intent of communicating a message to an audience, where the message is designed to further the goal or objective. In some implementations, the media can be AI generated using various generative models such as transformer-based models like ChatGPT, Google Gemini, Stable Diffusion, or others.

At 304, baseline neurometrics of the audience are measured. In some implementations, the baseline neurometrics are continually recorded and updated. For example, routing data collection from wearable neurometric measuring devices, such as a headband EEG, can provide general baseline neurometrics. In some implementations, baseline neurometrics are acquired during a laboratory or dedicating experiment session. It should be noted that the entire audience does not have to be measured. Instead, a subset of the audience can represent a portion of the entire audience can be measured, and the baseline neurometrics of the entire audience can be inferred from the measured subset. In some implementations, where a subset of the audience is measured, that subset can be analyzed for sufficient neurosynchrony to determine whether the subset is of sufficient size to be representative of the audience as a whole. Neurosynchrony can be determined based on a statistical analysis of each neurometric to identify whether there is consensus amongst the tested audience subsets.

At 306, neurometrics during audience exposure to the media or a portion of the media is measured. In some implementations, these measurements can occur in a laboratory or controlled environment. In some implementations, the neurometrics can be measured during exposure based on a detected neuro response indicating exposure based on prior experiments or data. In some implementations, neurometrics can be recorded any time it is known that the media is being presented and that some or all of the audience will be exposed.

Neurometrics can be an analysis of an audience member's brain patterns and can include the mental, psychological, and/or cognitive state of the audience member. Example neurometrics can include, but are not limited to affinity, attention, joy, empathy, contempt, confusion, credibility, disgust, fear, impulse, fatigue, apprehension, excitement, satisfaction, or others.

Similarly to 304, the neurometrics of the entire audience need not be measured. If only a subset or portion of the audience is measured, the result can, in some implementations, be inferred or expanded to the entire audience. It should further be noted that the subset measured for baseline neurometrics is not necessarily the same subset as is measured for the exposure neurometrics.

At 308, demographic data associated with the responsive audience is observed. In some implementations, the responsive audience can be the portion or subset of the audience that measurably responds to the media exposure. The responses can include, but are not limited to view time, clicks, attention spikes, commenting, sentiment shifts, purchases or conversions, votes, or other actions and reactions. In some implementations, the subset of the audience that responds is distinct from the subset of the audience that has neurometrics measured. Demographic data can include any detail regarding the individual audience members that are exposed to the media. An example of demographics can include age, location, gender, location type (e.g., urban, rural, international, local, etc.), platform of consumption (e.g., social media, news, television, etc.), online behavior, offline behavior, self-reported demographics, environment, weather, time of day, frequency of exposure, number of exposures, context of exposure, or others.

At 312, the media effectiveness is rated for each response. This can be, for example, generating a score for each sample of a group of media exposures based on which responses are received and/or the quantity of responses. In some implementations, the effectiveness of a particular sample of media is rated not only based on how impactful it is (i.e., how much response it develops), but whether the response aligns with the initially determined goals or objectives.

At 314, the audience is classified based on their response, demographics, and neurometrics. In some implementations, a predictive model is generated using a layered network approach and adjusting or training the network using machine learning methods. This predictive model can then identify or classify phenotypes within the audience to correlate the associated media samples that had the largest impact on each phenotype. In some implementations, at 316, the goals can be reviewed, refined, or otherwise improved based on the classification of the audience. For example, if it is determined that a particular audience is biased toward schadenfreude, then the goal for an advertising campaign of invoking “joy” and presenting a certain product as innovative may be less effective than an advertising campaign focused on informing about the disadvantages of competing products.

At 318, the neurometrics from 306 can be compared to additional neurometrics measured during an audience experience related to the media. For example, neurometrics for an audience viewing a preview for a movie, and then additional neurometrics for that audience (or a portion thereof) viewing the movie itself can be compared.

At 320, it is determined whether a cognitive mismatch exists between the audience's experience and their expectations based on the media. A cognitive mismatch can be detected, for example, by observing discontinuity in neurometrics between media exposure and during a related activity associated with a product. For example, an audience exposed to an advertisement for a sports car may show neurometrics including high levels of joy and synchrony during the advertisement. That same audience may then show low synchrony and/or joy when test driving the advertised sports car. This indicates that the product is not meeting the expectations established by the advertisement. In another example, the audience may show high joy and/or synchrony when test driving the car, but not during exposure to the advertisement. This may indicate that the advertisement is suboptimal for that audience.

If a cognitive mismatch is not detected, a positive presentation rating can be associated with a generated media at 324. This positive presentation rating can indicate that the media is accomplishing its desired goal, or otherwise performs well, and can be a blueprint or example for additional successful media. This positive rating can feed into 312 above in rating the media effectiveness. In some instances, positive presentation ratings can be tied to particular phenotypes, with additional metadata or context provided back into the rating system for future considerations.

If a cognitive mismatch is detected, a negative or adverse presentation rating can be associated with a generated media at 324. This positive presentation rating can indicate that the media is not accomplishing its desired goal, or otherwise performs poorly. This negative rating can feed into 312 above in rating the media effectiveness. In some instances, positive presentation ratings can be tied to particular phenotypes, with additional metadata or context provided back into the rating system for future considerations.

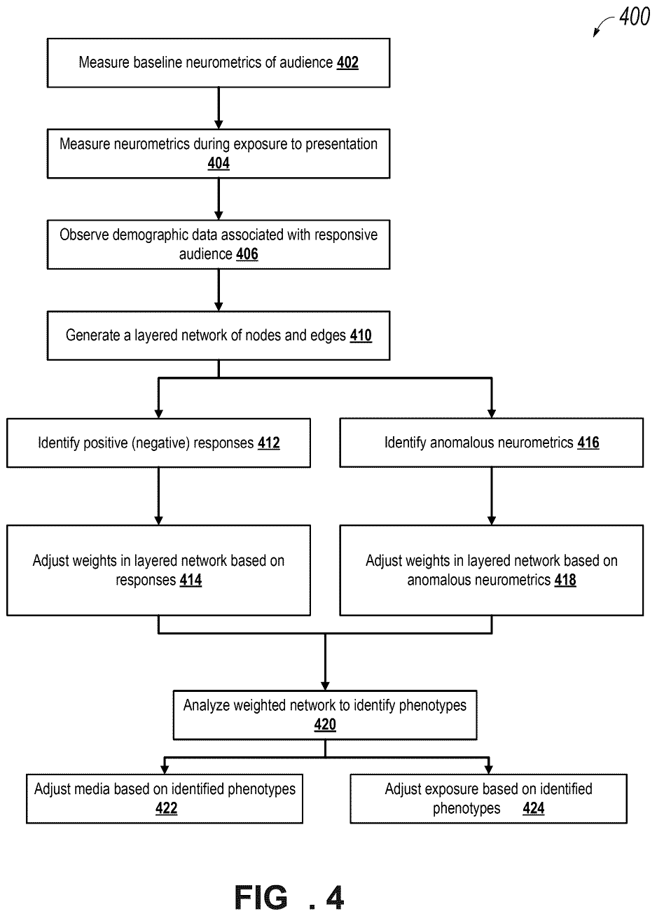

FIG. 4 is a flowchart of an example process 400 for classifying phenotypes based on a behavioral response to media. It will be understood that process 400 and related methods may be performed, for example, by any suitable system, environment, software, and hardware, or a combination of systems, environments, software, and hardware, as appropriate. For example, a system comprising a communications module, at least one memory storing instructions and other required data, and at least one hardware processor interoperably coupled to the at least one memory and the communications module can be used to execute process 400. In some instances, some or all of a portion of system 100 may be used to perform the operations of process 400.

At 402, a baseline neurometrics of the audience are measured. In some implementations, the baseline neurometrics are continually recorded and updated. For example, routing data collection from wearable neurometric measuring devices, such as a headband EEG, can provide general baseline neurometrics. 402 can be similar to 302 as described above with respect to FIG. 3.

At 404, neurometrics during a presentation of the media or a portion of the media to the audience are measured. In some implementations, these measurements can occur in a laboratory or controlled environment. In some implementations, the neurometrics can be measured during exposure based on a detected neuro response indicating exposure based on prior experiments or data. In some implementations, neurometrics can be recorded any time it is known that the media is being presented and that some or all of the audience will be exposed. In some implementations, 404 is similar to 304 and 306 as described above with respect to FIG. 3.

Similarly to 402, the neurometrics of the entire audience need not be measured. If only a subset or portion of the audience is measured, the result can, in some implementations, be inferred or expanded to the entire audience. It should further be noted that the subset measured for baseline neurometrics is not necessarily the same subset as is measured for the exposure neurometrics.

At 406, demographic data associated with the responsive audience is observed. In some implementations, the responsive audience can be the portion or subset of the audience that measurably responds to the media exposure. The responses can include, but are not limited to view time, clicks, attention spikes, commenting, sentiment shifts, purchases or conversions, votes, or other actions and reactions. In some implementations, the subset of the audience that responds is distinct from the subset of the audience that has neurometrics measured. Demographic data can include any detail regarding the individual audience members that are exposed to the media. For example, demographics can include age, gender, location, location type (e.g., urban, rural, international, local, etc.), platform of consumption (e.g., social media, news, television, etc.), online behavior, offline behavior, self-reported demographics, environment, weather, time of day, frequency of exposure, number of exposures, context of exposure, or others. In some implementations, 406 is similar to 308 of FIG. 3 above.

At 410, a layered network of nodes and edges is generated. The network can be similar to a neural network or other machine learning system. In some implementations, three layers of nodes are used. The first layer can include nodes for each neurometric. The second layer can include nodes for each demographic and the third layer can include nodes for each response. Edges can be drawn between every node, that is the network can be fully connected, or in a full mesh topology. In some implementations, the network is partially connected or pruned during training. Each edge can be weighted according to the associated relationship or strength of the relationship between two nodes. These weights can be adjusted during training of the network as described below. In general, the network is created as a predictive model, classification model, or both. It can be used for future improvements and present analysis of the media being consumed.

At 412, responses are identified from the audience that are the result of a positive effect, or negative effect from the media presentation. The responses to the media are identified and assessed as whether they align with the objectives of the media.

At 414, the weights of the layered network are adjusted based on the response data. In some implementations, these weights are adjusted as a multiplicative number between −1.0 and 1.0. Alternatively, weights can be between 0.0 and 1.0, or −10.0 and 10.0 or other suitable ranges. In some implementations, the weights are adjusted using machine learning training methods such as, stochastic gradient descent, mini-batch gradient descent, ADAM, RMSprop, L1 or L2regularization, or other techniques. In some implementations, in addition to modifying the weights, the network topology can be enhanced as well. For example, additional layers, recursions, or other features and/or hyperparameters can be adjusted.

At 416, anomalous neurometrics can be identified. Neurometrics can differ significantly from the baseline or the expected neurometrics during media presentation are identified. These anomalous neurometrics, or unique cases, can be analyzed to determine if and how much of an effect they have on responses, as well as if they apply to specific demographics or sets of demographics.

At 418, the weights of the layered network are adjusted based on the anomalous neurometrics. In some implementations, these weights are adjusted as a multiplicative number between 0.0 and 1.0. In some implementations, the weights are adjusted using machine learning training methods such as, stochastic gradient descent, mini-batch gradient descent, ADAM, RMSprop, L1 or L2 regularization, or other techniques. In some implementations, in addition to modifying the weights, the network topology can be enhanced as well. For example, additional layers, recursions, or other features and/or hyperparameters can be adjusted.

At 420, the trained or weighted network is analyzed, and certain phenotypes are identified within the audience. Phenotypes can be unique subsets of the audience that respond to particular messages or media. Phenotypes can share commonalities in demographics, neurometrics, responses, or a combination thereof. These phenotypes can be identified, for example, by portions of the network with comparatively higher weighted edges. In addition to identifying phenotypes, a strength of each phenotype, for example, as a percentage of the total audience, can be identified. These phenotypes can be used to improve future messaging, by more effectively speaking to the audience's proclivities.

At 422, media or presentation exposure is adjusted for future audiences based on the identified phenotypes. That is, the phenotypes in combination with their associated responses can be used to influence other individuals within an audience that are similarly situated. For example, a phenotype of “spreadsheet buyer” may be identified, who responds well to the presentation of numerical facts and statistics. In response, such audience members can be presented with more specification-based advertisement or media in the future, which can be expected to have a greater impact on that audience phenotype.

At 424, in addition to, or alternatively form adjusting the media or the exposure, the particular medium upon which the media is displayed, or the demographics to which the media exposure is aimed can be changed.

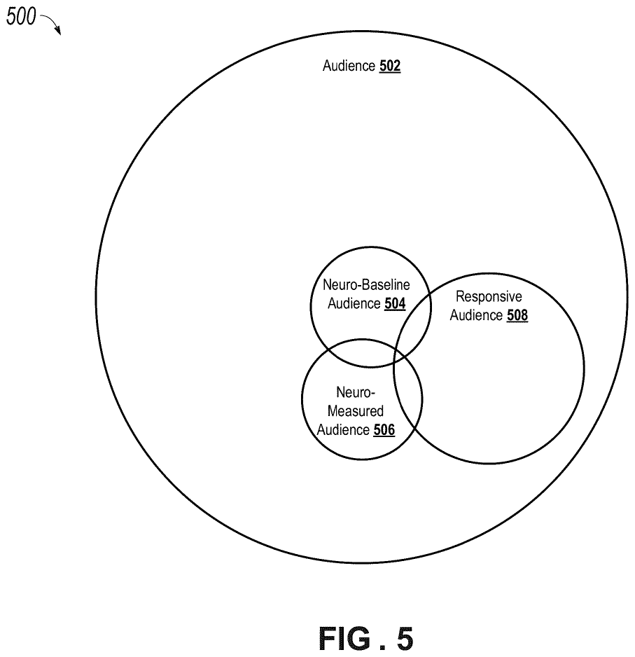

FIG. 5 is a Venn diagram 500 showing an example audience 502. The audience 502 can be any group of people that will be exposed to the media or message. In some implementations, the audience includes members with a large quantity of varying demographics. For example, the audience can include members from different age groups, in different locations, of different races or religions, as well as others. Some of audience 502 can be exposed to the media multiple times, or at a regular or semi-regular frequency.

The neuro-baseline audience 504 can represent the portion of the audience for which a neurometric baseline is measured. This neurometric baseline can be recorded in a laboratory or experimental setting or can be established ad-hoc based on a distributed network of neural sensors. In some implementations, the size of the neuro-baseline audience 504 need only be sufficient to provide an adequate statistical approximation of the audience 502 as a whole.

The neuro-measured audience 506 can represent the portion of the audience for which neurometric data during media exposure is present. Similarly to the neuro-baseline audience 504, the neuro-measured audience 506 can be recorded ad-hoc during real world media exposure, or in a laboratory or experimental setting.

The responsive audience 508 represents the portion of audience 502 that responds measurable to the media exposure. In some implementations, this includes audience members who purchase a product, click on a link, leave a comment or review, or otherwise interact with the media.

It should be noted that while the responsive audience 508, neuro-baseline audience 504 and neuro-measured audience 506 are illustrated as overlapping, they need not overlap, and can be three separate and distinct subsets of the audience 502. Additionally, in some implementations, there is perfect overlap. For example, there may be complete audience coverage for both the neuro-baseline audience 504 and the neuro-measured audience 506.

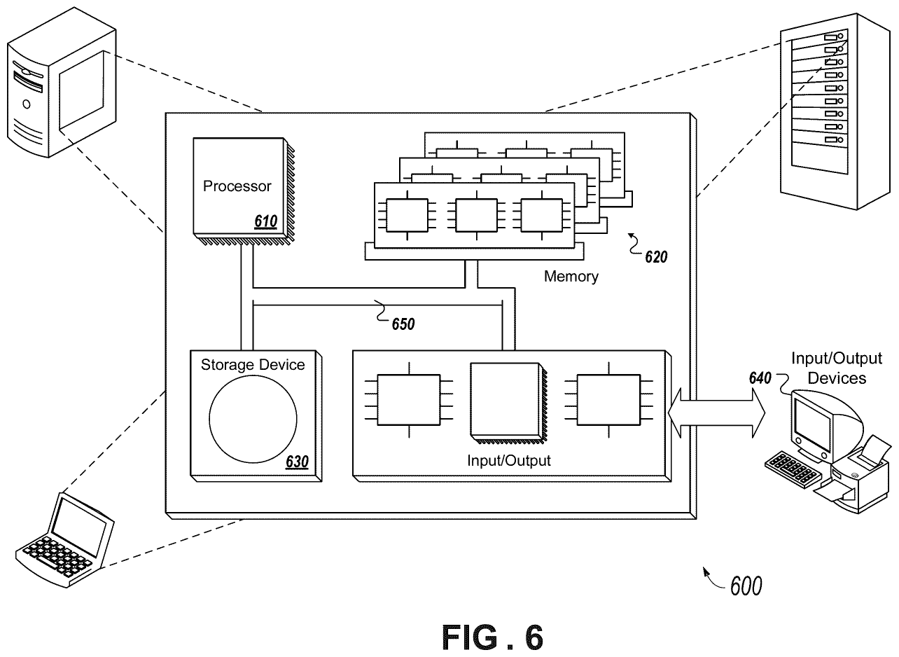

FIG. 6 is a schematic diagram of an example computing system 600. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit. The storage device 630 is capable of providing mass storage for the system 600. In one implementation, the storage device 630 is a computer-readable medium. In various different implementations, the storage device 630 may be a floppy disk device, a hard disk device, an optical disk device, or a tape device. The input/output device 640 provides input/output operations for the system 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example, semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device, such as a CRT (cathode ray tube) or LCD (liquid crystal display) monitor, for displaying information to the user and a keyboard, and a pointing device, such as a mouse or a trackball, by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication, such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order or sequential order shown, to achieve desirable results. In addition, other steps may be provided, or steps may be eliminated, from the described flows, and other components may be added to, or removed from, the described systems. Accordingly, other implementations are within the scope of the following claims.

This detailed description is merely intended to teach a person of skill in the art further details for practicing certain aspects of the present teachings and is not intended to limit the scope of the claims. Therefore, combinations of features disclosed above in the detailed description may not be necessary to practice the teachings in the broadest sense and are instead taught merely to describe particularly representative examples of the present teachings.

Unless specifically stated otherwise, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This detailed description, therefore, is not to be taken in a limiting sense, and the scope of various embodiments is defined only by the appended claims, along with the full range of equivalents to which such claims are entitled.

The abstract of the disclosure is provided to allow the reader to quickly ascertain the nature of the technical disclosure. It is submitted with the understanding that it will not be used to interpret or limit the scope or meaning of the claims. In addition, in the foregoing detailed description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the detailed description, with each claim standing on its own as a separate embodiment.

1. A method comprising:
identifying a set of baseline neurometrics for a first subset of an audience;
exposing the first subset of the audience to a collection of media and measuring neurometrics of the audience during exposure to the media;
identifying demographic data associated with the first subset of the audience, wherein the demographic data includes a plurality of parameters associated with individual members of the audience;
identifying demographic data associated with a second subset of the audience, the second subset of the audience comprising audience members that respond to at least a portion of the collection of media; and
generating a predictive model of the audience's response to the collection of media by:
generating a network comprising three layers of nodes, each node in the first layer of nodes representing a particular neurometric, each node in the second layer of nodes representing a particular parameter of the demographic data, and each node in the third layer representing a response type associated with the collection of media;
generating a first group of edges between each node in the first layer of nodes and each node in the second layer of nodes;
generating a second group of edges between each node in the second layer of nodes, and each node in the third layer of nodes;
for each individual member of the first subset of the audience, adjusting a weight of each edge of the first group of edges; and
for each individual member of the second subset of the audience, adjusting a weight of each edge of the second group of edges.

2. The method of claim 1, wherein measuring neurometrics comprises analyzing brainwave data to identify a psychological state of each individual of the first subset of the audience, wherein each neurometric represents a particular psychological condition for each individual.

3. The method of claim 1, wherein the baseline neurometrics comprise brainwave measurements of the first subset of the audience during a period when the first subset of the audience is not exposed to the media.

4. The method of claim 1, comprising, determining based on the baseline neurometrics, whether the first subset of the audience is sufficiently representative of the audience by determining that a neurosynchrony between members of the first subset of the audience is above a predetermined threshold.

5. The method of claim 1, wherein audience response to the portion of the media comprises at least one of:
a view, a selection of a hyperlink associated with the media;
a sale associated with the media;
a change in market share associated with the media; or
a reported sentiment improvement associated with the media.

6. The method of claim 1, wherein the demographic data comprises at least one of:
age;
location;
time;
frequency of media exposure; or
platform of media exposure.

7. The method of claim 1, wherein adjusting the weight of each edge of the first group of edges and adjusting the weight of each edge of the second group of edges comprises adjusting the weights using a stochastic gradient descent algorithm.

8. The method of claim 1, comprising:
identifying one or more phenotypes of the audience based on the predictive model; and
generating a list of most common audience phenotypes.

9. A non-transitory, computer-readable medium storing one or more instructions executable by a computer system to perform operations comprising:
identifying a set of baseline neurometrics for a first subset of an audience;
exposing the first subset of the audience to a collection of media and measuring neurometrics of the audience during exposure to the media;
identifying demographic data associated with the first subset of the audience, wherein the demographic data includes a plurality of parameters associated with individual members of the audience;
identifying demographic data associated with a second subset of the audience, the second subset of the audience comprising audience members that respond to at least a portion of the collection of media; and
generating a predictive model of the audience's response to the collection of media by:
generating a network comprising three layers of nodes, each node in the first layer of nodes representing a particular neurometric, each node in the second layer of nodes representing a particular parameter of the demographic data, and each node in the third layer representing a response type associated with the collection of media;
generating a first group of edges between each node in the first layer of nodes and each node in the second layer of nodes;
generating a second group of edges between each node in the second layer of nodes, and each node in the third layer of nodes;
for each individual member of the first subset of the audience, adjusting a weight of each edge of the first group of edges; and
for each individual member of the second subset of the audience, adjusting a weight of each edge of the second group of edges.

10. The medium of claim 9, wherein measuring neurometrics comprises analyzing brainwave data to identify a psychological state of each individual of the first subset of the audience, wherein each neurometric represents a particular psychological condition for each individual.

11. The medium of claim 9, wherein the baseline neurometrics comprise brainwave measurements of the first subset of the audience during a period when the first subset of the audience is not exposed to the media.

12. The medium of claim 9, the operations comprising, determining based on the baseline neurometrics, whether the first subset of the audience is sufficiently representative of the audience by determining that a neurosynchrony between members of the first subset of the audience is above a predetermined threshold.

13. The medium of claim 9, wherein audience response to the portion of the media comprises at least one of:
a view, a selection of a hyperlink associated with the media;
a sale associated with the media;
a change in market share associated with the media; or
a reported sentiment improvement associated with the media.

14. The medium of claim 9, wherein the demographic data comprises at least one of:
age;
location;
time;
frequency of media exposure; or
platform of media exposure.

15. The medium of claim 9, wherein adjusting the weight of each edge of the first group of edges and adjusting the weight of each edge of the second group of edges comprises adjusting the weights using a stochastic gradient descent algorithm.

16. The medium of claim 9, the operations comprising:
identifying one or more phenotypes of the audience based on the predictive model; and
generating a list of most common audience phenotypes.

17. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
identifying a set of baseline neurometrics for a first subset of an audience;
exposing the first subset of the audience to a collection of media and measuring neurometrics of the audience during exposure to the media;
identifying demographic data associated with the first subset of the audience, wherein the demographic data includes a plurality of parameters associated with individual members of the audience;
identifying demographic data associated with a second subset of the audience, the second subset of the audience comprising audience members that respond to at least a portion of the collection of media; and
generating a predictive model of the audience's response to the collection of media by:
generating a network comprising three layers of nodes, each node in the first layer of nodes representing a particular neurometric, each node in the second layer of nodes representing a particular parameter of the demographic data, and each node in the third layer representing a response type associated with the collection of media;
generating a first group of edges between each node in the first layer of nodes and each node in the second layer of nodes;
generating a second group of edges between each node in the second layer of nodes, and each node in the third layer of nodes;
for each individual member of the first subset of the audience, adjusting a weight of each edge of the first group of edges; and
for each individual member of the second subset of the audience, adjusting a weight of each edge of the second group of edges.

18. The system of claim 17, wherein measuring neurometrics comprises analyzing brainwave data to identify a psychological state of each individual of the first subset of the audience, wherein each neurometric represents a particular psychological condition for each individual.

19. The system of claim 17, wherein the baseline neurometrics comprise brainwave measurements of the first subset of the audience during a period when the first subset of the audience is not exposed to the media.

20. The system of claim 17, the operations comprising, determining based on the baseline neurometrics, whether the first subset of the audience is sufficiently representative of the audience by determining that a neurosynchrony between members of the first subset of the audience is above a predetermined threshold.
